(19) United States
(12) Patent Application Publication
(10) Pub. No.: US 2006/0176896 A1
(43) Pub. Date: Aug. 10, 2006

(54) Method and apparatus for transmitting data within a communication system

(76) Inventors: Edgar H. Callaway JR., Boca Raton, FL (US); Yan Huang, Weston, FL (US); David B. Taubenheim, Plantation, FL (US)

Correspondence Address: MOTOROLA, INC., 1303 EAST ALGONQUIN ROAD, IL01/3RD, SCHAUMBURG, IL, 60196, US

(21) Appl. No.: 11/055,459

(22) Filed: Feb. 10, 2005

(51) Int. Cl. H04J 3/16; H04J 3/22; H04L 12/413

(52) U.S. Cl. 370/437; 370/465; 370/445

(57) ABSTRACT

A node (101) using a contention-based access scheme will monitor a channel for a predetermined condition. If the predetermined condition is detected, the node will defect from the contention-based access scheme, where any generated messages will be immediately transmitted. Should a second condition be met, the node will again follow the contention-based access scheme.

### FIELD OF THE INVENTION

The present invention relates generally to transmission of data within a communication system and in particular, to a method and apparatus for determining when to transmit data within a communication system.

### BACKGROUND OF THE INVENTION

In communication systems, contention-based (CB) channel access protocols such as carrier-sense-multiple-access (CSMA) require a network node with a queued message to compete with other network devices also attempting to access the channel. In CSMA, for example, if the channel is idle (i.e., no other transmissions are occurring), transmission can take place; otherwise, the device waits (“backs off”) a random period of time and attempts to transmit again. Therefore, a device attempting to transmit is required to utilize a receiver to monitor the channel prior to transmission (i.e., to perform a “clear channel assessment,” or CCA). In many communication systems employing CSMA, monitoring the channel prior to transmission wastes power, since channels may be unoccupied a large fraction of the time. There is an additional power consumption penalty for receiving devices. Particularly, since the receiving device does not know exactly when the transmission is to be sent (e.g., at any time during the (IEEE) 802.15.4 “contention access period,” or CAP), it must keep its receiver active until the data transmission begins. Anything that can, on average, advance the transmission of messages to times earlier in the CAP will reduce the power the receiving device utilizes monitoring the channel prior to actual data reception.

Further, CB channel access methods are subject to security problems. A denial of service (DoS) attack on IEEE 802.11 networks (and, by extension, IEEE 802.15.4 networks) was described by the Australian Computer Emergency Response Team (AusCERT) in May 2004. Known as AA-2004.02, this alert was republished by the U.S. Computer Emergency Response Team (US-CERT) as vulnerability note VU#106678. In this scenario, an attacker transmits a continuous, low-level signal in a wireless local area network (WLAN) or wireless personal area network (WPAN) employing CSMA. Devices attempting to transmit using CSMA will sense the channel, detect the presence of the attacker's signal, and defer transmission to a later time. At that time, of course, the channel will still be occupied by the attacker, so the device will again defer transmission, and in fact will never transmit. Note that this is not physical-layer jamming by a strong, overpowering signal; it is a medium access control (MAC)-layer attack in which the channel access algorithm of the network device is used against it to prevent transmissions from ever occurring.

Therefore a need exists for a method and apparatus to determine when to transmit data while reducing power consumption for both transmitting and receiving devices within a communication system. Further, a need exists for a method to overcoming DoS attacks on communication systems employing CB channel access methods.

### BRIEF DESCRIPTION OF THE DRAWINGS

FIG. 1 is a block diagram of a communication system.

FIG. 2 is a logic diagram for operation of the communication system of FIG. 1 in accordance with a first embodiment.

FIG. 3 is a block diagram of a node within the communication system of FIG. 1.

FIG. 4 is a flow chart showing operation of the node of FIG. 1 in accordance with a first embodiment of the present invention.

### DETAILED DESCRIPTION OF THE DRAWINGS

In order to address the above-mentioned needs, a method and apparatus for determining when to transmit data is provided herein. More particularly, a network device is capable of operation in two states: a “cooperate” state, in which it follows a CB channel access method (where the term “channel” may refer to either a physical or a logical channel), and a “defect” state, in which it does not follow a CB channel access method, but instead simply transmits its queued message. (The word “defect” in this context is meant in the sense of the verb meaning “to desert one's companions”, and not in the sense of the noun meaning “a flaw or imperfection.”)

Transitions between these two states occur when predetermined criteria are met. For example, a node in the “cooperate” state using a slotted Carrier-sense-multiple-access (CSMA) algorithm will monitor a channel prior to every transmission attempt. If it determines the first monitored slot to be idle for x consecutive transmission attempts, the node will transition to the “defect” state, and any queued message will be immediately transmitted on the monitored slot without following the CSMA algorithm (i.e., without first monitoring or otherwise determining the channel status).

Should the node not receive an acknowledgement (ACK) for a transmitted message, the node will transition to the “cooperate” state, and again follow the CSMA channel access algorithm. It will remain in the “cooperate” state until it again determines the first monitored slot to be idle for x consecutive transmission attempts, at which point it will again transition to the “defect” state. In this example, the predetermined criterion for transitioning from the “cooperate” state to the “defect” state is the determination that the first monitored slot has been idle for x consecutive transmission attempts; the predetermined criterion for transitioning from the “defect” state to the “cooperate” state is the lack of a received ACK following a transmitted message.

Those of ordinary skill in the art recognize that acknowledgements need not necessarily take the form of dedicated messages sent in reply to a transmitted message; other forms of acknowledgements, including passive acknowledgements (e.g., overhearing the retransmission of a sent message) and acknowledgements contained or implied in other types of messages, are also possible while remaining within the scope of the present invention.

In terms of message latency and device power consumption, the above-described method for transmission is superior to CSMA under all conditions except high offered data rates in the largest networks. Under these conditions, the channel is largely occupied, and the time the local device spends defecting is not profitably used. However, even under this condition the penalty paid is less than five percent. When using the above-described transmission technique, the performance in terms of latency and power consumption is better for the smaller quantity of packets frequently found in wireless sensor networks.

The present invention encompasses a method for transmitting messages within a communication system. The method comprises the steps of transmitting messages on a channel utilizing a channel access protocol that is at least partially contention-based. A condition is evaluated against a predetermined criterion. Messages are then transmitted on the channel without using the channel access protocol when the condition satisfies the predetermined criterion.

The present invention additionally encompasses a method for transmitting data. The method comprises the steps of transmitting messages on a channel utilizing a contention-based channel access protocol. A determination is made that one of the following has occurred: (1) that the channel has been occupied for a predetermined period of time; or (2) that a number of consecutive transmission attempts has occurred for which a slot has been idle. Messages are then transmitted on the channel without using the CSMA transmission protocol when (1) or (2) has occurred.

The present invention additionally encompasses an apparatus comprising a transmitter transmitting messages on a channel utilizing a channel access protocol that is at least partially contention-based. The logic circuitry evaluates a condition against a predetermined criteria and instructing the transmitter to transmit messages on the channel without using the channel access protocol when the condition satisfies the predetermined criterion.

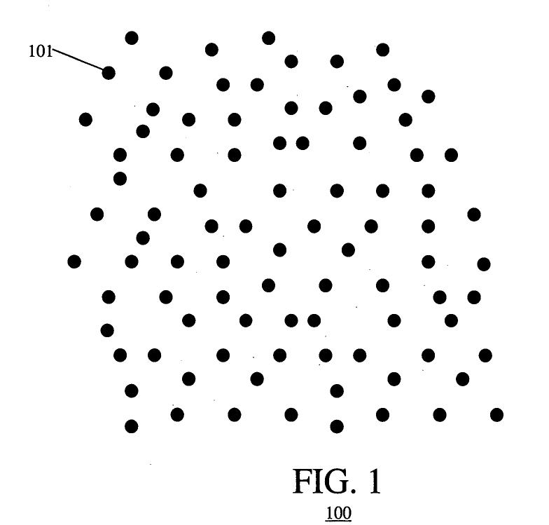

Turning now to the drawings, wherein like numerals designate like components, FIG. 1 illustrates communication system 100 in accordance with the preferred embodiment of the present invention. Communication system 100 preferably utilizes a communication system protocol defined by the IEEE 802.15.4 Low Rate Wireless Personal Area Network standard, however, one of ordinary skill in the art will recognize that other communication system protocols may be utilized without varying from the scope of the invention. For example, communication system 100 may utilize communication system protocols such as, but not limited to, the IEEE 802.11 Wireless Local Area Network standard or the IEEE 802.15.3 High Rate Wireless Personal Area Network standard.

As shown, communication system 100 comprises a plurality of nodes 101, with each node 101 capable of short-range communication to neighboring nodes. Additionally, as one of ordinary skill in the art will recognize, transmissions between two nodes within communication system 100 may take place through intervening nodes, with the intervening nodes receiving a source transmission, and “repeating” the source transmission until the source transmission reaches its destination node.

Nodes 101 within communication system 100 utilize a first communication system protocol for channel access. In a preferred embodiment of the present invention, a CB protocol is utilized such as a CSMA protocol. Such a CSMA protocol is described in detail in R. M. Metcalf and D. R. Boggs, “Ethernet: Distributed packet switching for local computer networks,” Commun. ACM, vol. 19, no. 7, July 1976, pp. 395-404. CSMA provides a foundation for numerous variations. Examples of CSMA type MAC protocols include IEEE 802.11b wireless LANs operating in DCF (Distributed Coordination Function) mode, and HomePlug power line LANs.

With CSMA, geographically distributed nodes 101 share a common communication channel, which may be a wired or wireless channel. Each node follows the same CSMA protocol. Nodes 101 determine the success of a transmitted message by detecting if there are any collisions. Particularly, if, after a transmission, an ACK is received from the receiving node, no collision has occurred. However, if, after transmission, an ACK is not received, it is assumed that a collision has occurred. As a result, CSMA based protocols rely on received acknowledgements to monitor the status of the transmitted message. In general, CB protocols do not provide assurance that message collisions will not occur; these protocols must provide a recovery mechanism for message collisions, such as retransmission if an ACK is not received.

In a slotted CSMA protocol, a node having message traffic at the MAC layer queued to send must first determine whether the medium is idle or busy by carrier sensing. If the medium is determined to be idle for a predetermined amount of time, the node transmits a queued message. If the medium is determined to be busy, the node will carry out a random back off procedure after which the node will again monitor the medium for activity. A common random back off procedure may utilize the Truncated Binary Exponential Back-off (TBEB) scheme. In this scheme, the node waits a random number of slots, which is uniformly distributed within a window the size of which is an exponential function of the number of consecutive times the node has determined the medium to be active. Commonly, after a predetermined maximum number of failed transmission attempts, efforts at channel access cease for the queued message, and upper layers in the protocol stack are informed of the transmission difficulty due to channel access failure.

As noted above, since CSMA cannot rely on the capability of nodes to detect collisions, every transmitted message requires a positive acknowledgment from the receiving node within a predetermined time period following transmission of the message. If the sending node receives no acknowledgment within the time period, the message is considered lost; commonly, the sending node then restarts the CSMA protocol in another attempt to transmit the message.

As discussed above, in many communication systems employing CSMA, monitoring the channel prior to transmission wastes power, since channels may be unoccupied a large fraction of the time the network is in operation. Additionally, as discussed, there is an additional power consumption penalty at the device targeted to receive any transmission. In order to address these issues, in the preferred embodiment of the present invention nodes 101 are allowed to “defect” from performing CSMA when certain system criteria are met. Thus, nodes 101 attempting to access a channel may reduce their power consumption by “defecting” from the CSMA protocol and immediately transmitting messages, without first monitoring the channel. Further, the target device will also reduce its power consumption, since it receives its message without having to monitor the channel for an extended period.

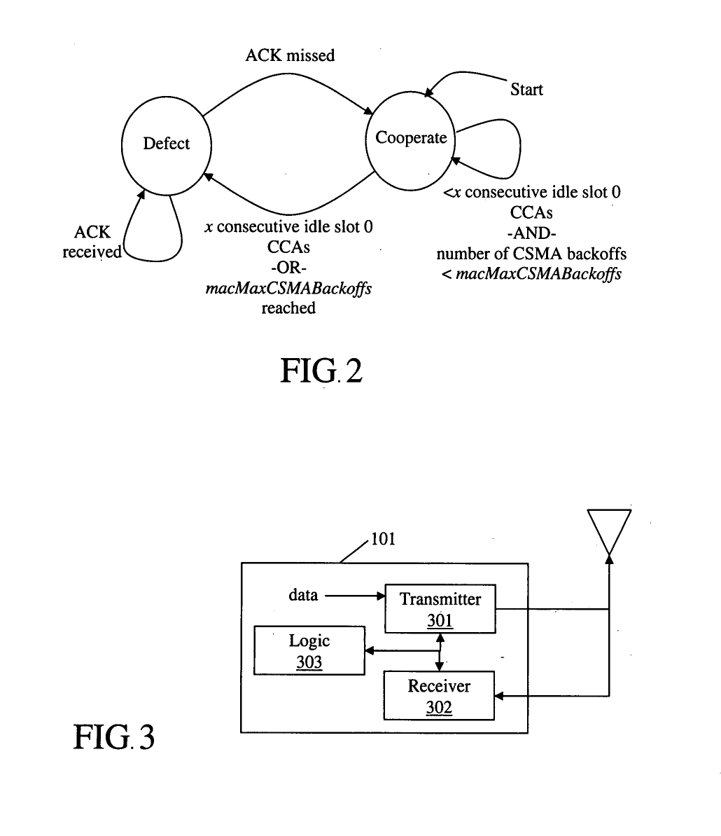

A device may be considered as being in either a “cooperate” state or a “defect” state, as shown in FIG. 2. When in cooperate state 202, the device will transmit messages according to a CB channel access method (e.g., CSMA). When in the defect state 204, the device will transmit messages immediately, without performing a CCA or other portions of a CB channel access protocol. While in cooperate state 202 the device evaluates one or more criteria for the cooperate-to-defect transition; only when these criteria are satisfied will the device transition from cooperate state 202 to defect state 204. An exemplary criterion for transitioning from cooperate state 202 to defect state 204 is the determination using slotted CSMA that the first monitored slot has been idle for at least x consecutive transmission attempts, where x has a predetermined value. It should be noted that if x is too small, it is likely that the local device will enter defect state 204 when the channel is not idle, enduring packet collisions and data delivery delays before it returns to cooperate state 202. Conversely, if it is too large, the local device will not enter defect state 204 on an idle channel promptly, and will not take full advantage of defection. In a preferred embodiment of the present invention x=2. While in the cooperating state 202 the device counts the number of consecutive transmission attempts for which the first monitored slot was idle; while this value is less than x the device remains in cooperate state 202. When this value reaches x, the device transitions from cooperate state 202 to defect state 204.

In a second embodiment of the present invention, the criterion for transitioning from cooperate state 202 to defect state 204 is the detection of a channel access failure (i.e., failure to access the channel due to detected transmissions on the channel). Should this occur, the device transitions from cooperate state 202 to defect state 204, and immediately sends the message, rather than informing the upper layers of the protocol stack about the failure. If the channel is truly occupied, this transmission may cause interference; however, if the network is under an AusCERT AA-2004.02-type DoS attack, the data will be successfully transmitted—thus defeating the DoS attack.

While in defect state 204 the device evaluates one or more criteria for the defect-to-cooperate transition; only when these criteria are satisfied will the device transition from defect state 204 to cooperate state 202. An exemplary criterion for transitioning from defect state 204 to cooperate state 202 is the non-reception of an ACK expected from a transmitted message. While in defect state 204 the device checks for ACKs received for transmitted messages; as long as an ACK is received for each transmitted message the device remains in defect state 204. When an ACK is not received for a transmitted message, the device transitions from cooperate state 202 to defect state 204.

The transition criteria described in the above embodiments are exemplary only; other criteria may be employed, singly or in combination, or in combination with the given exemplary criteria, while remaining within the scope of the present invention.

The embodiment shown in FIG. 2 has the device starting in cooperate state 202. In an alternative embodiment the device starts in defect state 204, and will transmit its first message without first performing a CB channel access protocol. This embodiment has the advantage that the first message transmission attempt will occur without any possible delay associated with the CB access protocol. However, this transmission may cause a packet collision that could have been less likely, had the device started in the cooperate state 202.

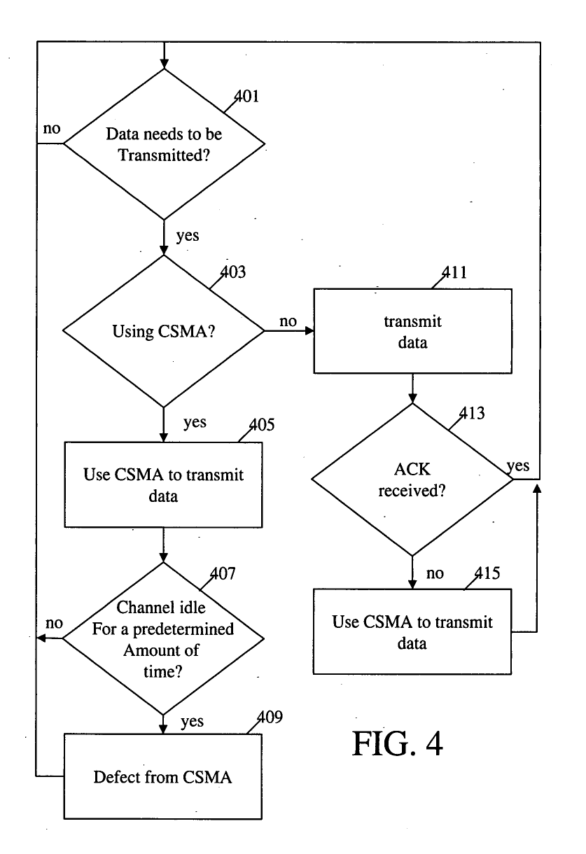

FIG. 3 is a block diagram of node 101. As shown, node 101 comprises logic circuitry 303, receive circuitry 302, and transmit circuitry 301. Logic circuitry 303 preferably comprises a microprocessor controller, such as, but not limited to, a Motorola HC08 microprocessor. In the preferred embodiment of the present invention logic circuitry 303 serves as a means of controlling node 101, and as a means of determining when to transmit messages (within the MAC layer). Additionally receive and transmit circuitry 302 and 301 are common circuitry known in the art for communication utilizing a well known communication protocols, and serve as a means of transmitting and receiving messages. For example, in the preferred embodiment of the present invention receiver 302 and transmitter 301 utilize the IEEE 802.15.4 wireless communication system protocol. Other possible transmitters and receivers include, but are not limited to transceivers utilizing Bluetooth™, neuRFon™, IEEE 802.11, or HyperLAN™ protocols.

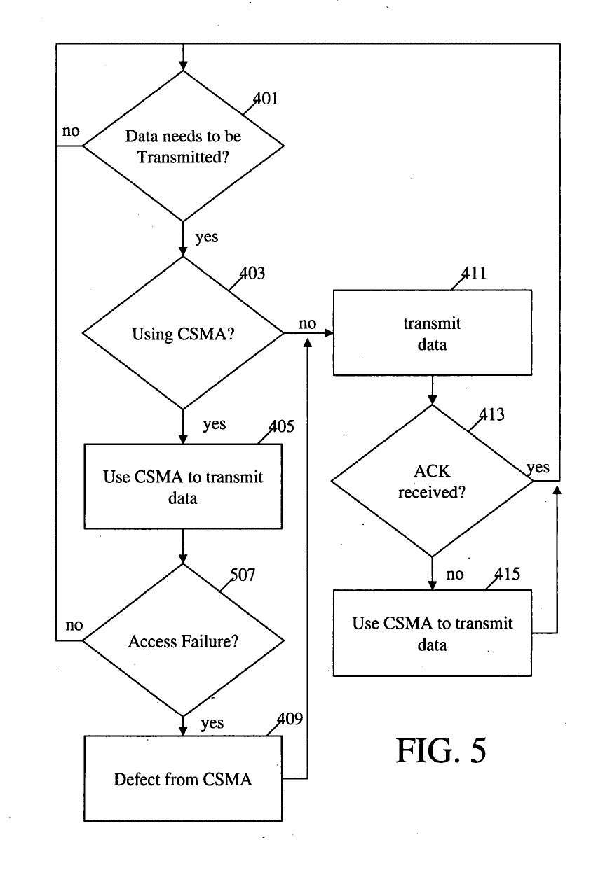

FIG. 4 is a flow chart showing operation of node 300 of FIG. 1 in accordance with a first embodiment of the present invention. As discussed above, in the first embodiment of the present invention an at least a partially contention based channel access method is initially performed; i.e., cooperate state 202 is the state first entered by the device. The logic flow begins at step 401. At step 403, logic unit 303 sets the state of node 101 to cooperate state 202. At step 405, logic unit 303 determines if a message needs to be transmitted on a channel. If at step 405 it is determined that data needs to be transmitted, the logic flow continues to step 407, otherwise the logic flow returns to step 405. At step 407 logic unit 303 determines if node 101 is in cooperate state 202. If it is determined that node 101 is in cooperate state 202, the logic flow continues to step 409 where the at least partially CB channel access method is performed, and the message is transmitted per the policies of that method. For example, if the CB channel access method is CSMA, logic unit 303 will instruct receiver 302 to monitor the channel for a fixed amount of time. If the channel is determined to be idle, logic unit 303 will instruct transmitter 301 to transmit the message on the channel. If the medium is determined to be busy, logic unit 303 will carry out a random back off procedure after which logic unit 303 will instruct receiver 302 to again monitor the channel.

After the message has been sent, or after the CB channel access method has otherwise completed, logic flow continues to step 411. At step 411, the criteria for the cooperate-to-defect state transition is tested by logic unit 303. In other words, a condition is evaluated against a predetermined criterion. As discussed above, if the CB channel access method is slotted CSMA, an example condition is that the first monitored slot idle time has been existing for x consecutive transmission attempts. In a second embodiment, also discussed above, an example condition is the detection that the channel has been occupied for a predetermined amount of time resulting in a channel access failure. This step may simply be performed by logic unit 303 determining that the message has not been sent after a predetermined number of attempts.

If at step 411 it is determined that the criteria have not been met, the logic flow returns to step 405, otherwise it continues to step 413. At step 413, logic unit 303 sets the state of node 101 to defect state 204. The logic flow then returns to step 405 where further messages will be transmitted without using the contention-based channel access procedure. In other words, messages will be transmitted immediately when they become available for transmission.

Returning to step 407, if logic unit 303 determines that node 101 is not in cooperate state 202, the logic flow continues to step 415, where any messages are immediately transmitted by transmitter 301. Following this step, the logic flow continues to step 417, at which a second condition is evaluated against a second predetermined criterion. In this evaluation, the criteria for the defect-to-cooperate state transition are tested by logic unit 303. As discussed above, if the CB channel access method is slotted CSMA, an example criterion is the non-reception of an expected ACK for the transmitted message. If it is determined that the criteria have not been met, the logic flow returns to step 403, otherwise the logic flow returns to step 405.

While the invention has been particularly shown and described with reference to a particular embodiment, it will be understood by those skilled in the art that various changes in form and details may be made therein without departing from the spirit and scope of the invention. For example, multiple criteria may be simultaneously used, with defection from CSMA occurring when an access attempt has failed (i.e., channel occupied for a predetermined amount of time) and when a number of consecutive transmission attempts has passed for which a slot has been idle. It is intended that such changes come within the scope of the following claims.

1. A method for transmitting messages within a communication system, the method comprising the steps of:
transmitting messages on a channel utilizing a channel access protocol that is at least partially contention-based;
evaluating a condition against a predetermined criterion; and
transmitting messages on the channel without using the channel access protocol when the condition satisfies the predetermined criterion.

2. The method of claim 1 wherein the step of evaluating the condition comprises the step of evaluating a slot idle time.

3. The method of claim 1 wherein the step of evaluating the condition comprises the step of evaluating a number of consecutive transmission attempts for which a slot has been idle.

4. The method of claim 1 wherein the step of transmitting the messages on the channel without using the channel access protocol comprises the step of immediately transmitting messages on the channel when the messages becomes available for transmission.

5. The method of claim 1 wherein the step of evaluating the condition comprises the step of determining that the channel has been occupied for a predetermined amount of time.

6. The method of claim 5 wherein the step of determining that the channel has been occupied for the predetermined amount of time comprises the step of determining that an access attempt has failed.

7. The method of claim 5 wherein the step of determining that the channel has been occupied for the predetermined amount of time comprises the step of determining that a message not been transmitted after a number of attempts.

8. The method of claim 1 further comprising the steps of:
evaluating a second condition against a second predetermined criterion; and
transmitting messages on the channel, utilizing the channel access protocol when the second condition satisfies the second predetermined criterion.

9. The method of claim 8 wherein the step of evaluating the second condition comprises the step of determining if no acknowledgment has been received for a transmitted message.

10. The method of claim 1 wherein the step of transmitting messages on the channel, utilizing the channel access protocol comprises the step of transmitting messages on the channel utilizing a Carrier-sense-multiple-access (CSMA) protocol.

11. A method for transmitting data, the method comprising the steps of:
transmitting messages on a channel utilizing a contention-based channel access protocol;
determining that one of the following has occurred:
(1) that the channel has been occupied for a predetermined period of time; or
(2) that a number of consecutive transmission attempts has occurred for which a slot has been idle; and
transmitting messages on the channel without using the CSMA transmission protocol when (1) or (2) has occurred.

12. The method of claim 11 wherein the step of transmitting messages on the channel without using the CSMA channel access protocol comprises the step of immediately transmitting messages on the channel when the messages becomes available for transmission.

13. The method of claim 11 further comprising the steps of:
determining if no acknowledgment has been received for a transmitted message; and
transmitting further messages on the channel, utilizing the channel access protocol when no acknowledgment has been received.

14. The method of claim 11 wherein the step of transmitting messages on the channel utilizing contention-based access protocol comprises the step of transmitting messages on the channel utilizing a Carrier-sense-multiple-access (CSMA) protocol.

15. An apparatus comprising:
a transmitter transmitting messages on a channel; and
logic circuitry instructing the transmitter to transmit via a channel access protocol that is at least partially contention-based, and evaluating a condition against a predetermined criteria then instructing the transmitter to transmit messages on the channel without using the channel access protocol when the condition satisfies the predetermined criterion.

16. The apparatus of claim 15 wherein the condition comprises a slot idle time.

17. The apparatus of claim 15 wherein the condition comprises a number of consecutive transmission attempts for which a slot has been idle.

18. The apparatus of claim 15 wherein the logic circuitry instructs the transmitter to immediately transmit messages when the condition satisfies the predetermined criterion.

19. The apparatus of claim 15 wherein the condition comprises a fact that the channel has been occupied for a predetermined amount of time.

20. The apparatus of claim 15 wherein the condition comprises a fact that an access attempt has failed.
